(19) United States
(12) Patent Application Publication
(10) Pub. No.: US 2018/0131078 A1
(43) Pub. Date: May 10, 2018

(54) LENSED BASE STATION ANTENNAS HAVING AZIMUTH BEAM WIDTH STABILIZATION

(71) Applicant: CommScope Technologies LLC, Hickory, NC (US)

(72) Inventors: Alireza Shooshtari, Allen, TX (US); Igor Timofeev, Dallas, TX (US)

(21) Appl. No.: 15/805,443

(22) Filed: Nov. 7, 2017

Related U.S. Application Data
(60) Provisional application No. 62/420,140, filed on Nov. 10, 2016.

(51) Int. Cl. H01Q 1/24; H01Q 19/06; H01Q 21/00; H01Q 21/26

(52) U.S. Cl. CPC H01Q 1/246; H01Q 21/26; H01Q 21/0031; H01Q 19/06

(57) ABSTRACT

A lensed antenna is provided. The lensed antenna includes a linear array of radiating units that are spaced apart from one another in a longitudinal direction. Each radiating unit includes a first radiating element and a second radiating element that is arranged proximate to the first radiating element. Either of the first radiating element or the second radiating element is operable to resonate at a first frequency and a combination of the first radiating element and the second radiating element is operable to resonate at a second frequency that is different from the first frequency. A lens is positioned to receive electromagnetic radiation from at least one of the radiating units.

### CROSS-REFERENCE TO RELATED APPLICATION

The present application claims priority to U.S. Provisional Patent Application Ser. No. 62/420,140, filed Nov. 10, 2016, the entire content of which is incorporated by reference herein as if set forth in its entirety.

### FIELD OF THE INVENTION

The present invention generally relates to radio communications and, more particularly, to lensed antennas utilized in cellular and other communications systems.

### BACKGROUND

Cellular communications systems are well known in the art. In a cellular communications system, a geographic area is divided into a series of regions that are referred to as “cells,” and each cell is served by a base station. The base station may include one or more antennas that are configured to provide two-way radio frequency (“RF”) communications with mobile subscribers that are geographically positioned within the cell served by the base station. In many cases, each base station provides service to multiple “sectors,” and each of a plurality of antennas will provide coverage for a respective one of the sectors. Typically, the sector antennas are mounted on a tower or other raised structure, with the radiation beam(s) that are generated by each antenna directed outwardly to serve the respective sector.

A common wireless communications network plan includes a multi-column array that may be driven by a feed network to produce two or more beams from a single phased array antenna. For example, if multi-column array antennas are used that each generates two beams, then only three antennas may be required for a six-sector configuration. Antennas that generate multiple beams are disclosed, for example, in U.S. Patent Publication No. 2011/0205119, which is incorporated herein by reference.

Applications for multi-beam antennas may require a minimum pattern cross-over to cover a sector while lowering interference. Different types of conventional multi-beam arrays include (1) a phased array driven by a Butler matrix and (2) a multi-column phased array combined with a cylindrical lens or an array of special lenses. However, each of these approaches may not provide sufficient cross-over, particularly in the context of broad band antennas. For example, a desired cross-over of 10 dB may be difficult to achieve with antennas operating in a frequency band of 1.69-2.69 GHz. Brief reference is made to FIG. 1 which illustrates a cross-over of about 3 dB in a conventional multi-beam lensed base station antenna. A cross-over of 10 dB or greater in a broad band multi-beam base station antenna is desired.

### SUMMARY

Some embodiments of the inventive concept are directed to a lensed antenna, comprising a linear array of a plurality of radiating units that are spaced apart from one another in a longitudinal direction and that each include a first radiating element and a second radiating element that is arranged proximate to the first radiating element. Either of the first radiating element or the second radiating element is operable to resonate at a first frequency and a combination of the first radiating element and the second radiating element is operable to resonate at a second frequency that is different from the first frequency. A lens is positioned to receive electromagnetic radiation from at least one of the plurality of radiating units. First electromagnetic radiation that exits the lens that corresponds to the first frequency comprises a first electric field aperture and second electromagnetic radiation that exits the lens that corresponds to the second frequency comprises a second electric field aperture that is different from the first electric field aperture.

In other embodiments, an aperture ratio of the first electric field aperture to the second electric field aperture is proportionally related to a frequency ratio of the second frequency to the first frequency.

In still other embodiments, the aperture ratio is related to the frequency ratio by a constant of proportionality that is between 0.9 and 1.1.

In still other embodiments, the lens comprises a cylindrical lens having a lens longitudinal axis. The first radiating element comprises crossed dipoles and the second radiating element comprises crossed dipoles that are radially spaced apart from the first radiating element.

In still other embodiments, a center-to-center distance between the first radiating element and the second radiating element is in a range from about 50 mm to about 90 mm.

In still other embodiments, a center-to-center distance between the first radiating element and the second radiating element is in a range from about 0.3 times a wavelength corresponding to the second frequency to about 0.7 times the wavelength corresponding to the second frequency.

In still other embodiments, a center-to-center distance between the first radiating element and the second radiating element is in a range from about 0.5 times a wavelength corresponding to the second frequency to about 0.6 times the wavelength corresponding to the second frequency.

In still other embodiments, a center-to-center distance between the first radiating element and the second radiating element is in a range from about 80 mm to about 90 mm.

In still other embodiments, a −12 dB azimuth beam width variation of the antenna at a frequency range from 1.7 GHz to 2.7 GHz is greater than about two degrees and less than about five degrees.

In still other embodiments, a −12 dB azimuth beam width variation of the antenna at a frequency range from 1.7 GHz to 2.7 GHz is less than about eight percent of the 12 db azimuth beamwidth.

In still other embodiments, the first electromagnetic radiation and the second electromagnetic radiation have the same phase and the same polarity.

In still other embodiments, the first radiating element comprises a crossed dipole and the second radiating element comprises a horizontal-vertical hybrid dipole that is radially spaced apart from the first radiating element.

In still other embodiments, the horizontal-vertical hybrid dipole comprises two vertical radiating elements that are radially spaced apart from one another and that are spaced apart from one another in a direction that is parallel to the lens longitudinal axis, and a horizontal radiating element that is between the two vertical radiating elements.

In still other embodiments, a center-to-center distance between the first radiating element and the second radiating element is in a range from about 90 mm to about 110 mm.

In still other embodiments, a center-to-center distance between the first radiating element and the second radiating element is in a range from about 0.6 times a wavelength corresponding to the second frequency to about 0.8 times the wavelength corresponding to the second frequency.

In still other embodiments, the lens comprises a spherical lens array that includes a plurality of spherical lenses that are arranged adjacent one another in a first direction. The first radiating element comprises a first crossed dipole and the second radiating element comprises a second crossed dipole that is radially spaced apart from the first crossed dipole in a direction that is orthogonal to the first direction. The first crossed dipole and the second crossed dipole are adjacent a corresponding one of the plurality of spherical lenses.

In still other embodiments, the antenna further comprises a plurality of single crossed dipoles, wherein one of the plurality of single crossed dipoles is adjacent a second one of the plurality of spherical lenses.

In still other embodiments, ones of the plurality of radiating units are arranged alternatively with ones of the single crossed dipoles in the first direction. The plurality of spherical lenses comprises a spherical lens corresponding to each of the plurality of radiating units and the plurality of single dipoles.

In still other embodiments, the first radiating element is spaced apart from the second radiating element at a distance in a range of about 300 mm to about 360 mm.

In still other embodiments, the lens comprises a cylindrical lens having a lens longitudinal axis that extends in a first direction. The first radiating element comprises a first crossed dipole and the second radiating element comprises a second crossed dipole that is radially spaced apart from the first crossed dipole in a direction that is orthogonal to the first direction.

In still other embodiments, the first radiating element comprises a box-style radiator that includes four dipoles arranged in a square. The second radiating element comprises a parasitic radiator that includes parasitic elements that are adjacent a perimeter of the box-style radiator.

In still other embodiments, the box-style radiator is configured to resonate at a low end of a broadband frequency range. A combination of the parasitic radiator and the box-style radiator is configured to resonate at a high end of the broadband frequency range.

In still other embodiments, the low end of the broadband frequency range is about 1.7 GHz and the high end of the broadband frequency range is about 2.7 GHz.

Some embodiments of the inventive concept are directed to a lensed antenna that comprises a plurality of radiating units that are arranged in a linear array, each of the plurality of radiating units comprising a first radiating element and a second radiating element that is arranged proximate to the second radiating element. The first radiating element comprises a dipole and the second radiating element comprises a parasitic radiating element. The first radiating element is operable to resonate at a first frequency and a combination of the first radiating element and the second radiating element is operable to resonate at a second frequency that is different from the first frequency. A lens is positioned to receive electromagnetic radiation from the plurality of radiating units.

In further embodiments, first electromagnetic radiation that exits the lens that corresponds to the first frequency comprises a first electric field aperture and second electromagnetic radiation that exits the lens that corresponds to the second frequency comprises a second electric field aperture that is different from the first electric field aperture.

In still further embodiments, an aperture ratio of the first electric field aperture to the second electric field aperture is related to a frequency ratio of the second frequency to the first frequency by a constant of proportionality that is between 0.8 and 1.2.

It is noted that aspects of the invention described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.

### BRIEF DESCRIPTION OF THE DRAWINGS

FIG. 1 is a diagram showing a cross-over in the radiation pattern of a conventional multi-beam base station antenna.

FIGS. 2A and 2B are schematic side views illustrating azimuth beam width stability in a lens antenna according to some embodiments of the present invention.

FIG. 3 is a diagram showing an exploded view of an example multiple beam base station antenna system according to some embodiments of the present invention.

FIG. 4 is a diagram showing an assembled view of the multiple beam antenna base station antenna system of FIG. 3.

FIG. 5 is a schematic of an example linear antenna array for use in a multi-beam base station antenna system according to some embodiments of the present invention.

FIG. 6 is a schematic example of a radiating unit that may exhibit improved azimuth beam width stabilization according to some embodiments of the present invention.

FIG. 7 is a side view of the radiating unit of FIG. 6.

FIG. 8A is a graph illustrating plots of the azimuth radiation pattern for one of the radiating elements in the radiating unit described with reference to FIG. 6 at different respective frequencies in a broadband frequency spectrum.

FIG. 8B is a table including data corresponding to the graph of FIG. 8A.

FIG. 9 is a graph with plots of azimuth beam width versus frequency for the two radiating elements of radiating unit as described above regarding FIG. 6 and a second graph with plots of beam width versus frequency for a conventional radiating element.

FIG. 10 is a partial schematic perspective view of a lensed antenna including pairs of radiating elements according to some embodiments of the present invention.

FIG. 11 is a graph plotting azimuth beam width measured at 12 dB down from peak emission versus frequency of the lensed antenna of FIG. 10.

FIG. 12 is a partial schematic perspective view of a lensed antenna including pairs of radiating elements according to some other embodiments of the present invention.

FIG. 13 a graph plotting azimuth beam width measured at 12 dB down from peak emission versus frequency of the lensed antenna of FIG. 12.

FIG. 14 is a partial schematic perspective view of a lensed antenna including pairs of radiating elements according to some embodiments of the present invention.

FIG. 15A is a graph illustrating plots of the azimuth radiation pattern for one of the pairs of radiating elements described with reference to FIG. 14 at different respective frequencies in a broadband frequency spectrum.

FIG. 15B is a respective table including data corresponding to the graph of FIG. 15A.

FIGS. 16 and 17 are a partial schematic diagram of a linear array of radiating elements and a schematic side view of a lensed base station antenna, respectively, according to some embodiments of the present invention.

FIG. 18A is a graph illustrating plots of the azimuth radiation pattern for pairs of radiating elements described with reference to FIGS. 16 and 17 at different respective frequencies in a broadband frequency spectrum.

FIG. 18B is a table including data corresponding to the graph of FIG. 18A.

FIG. 19 is a graph illustrating plots of the azimuth radiation pattern for pairs of radiating elements described with reference to FIGS. 16 and 17 at different respective frequencies in a broadband frequency spectrum according.

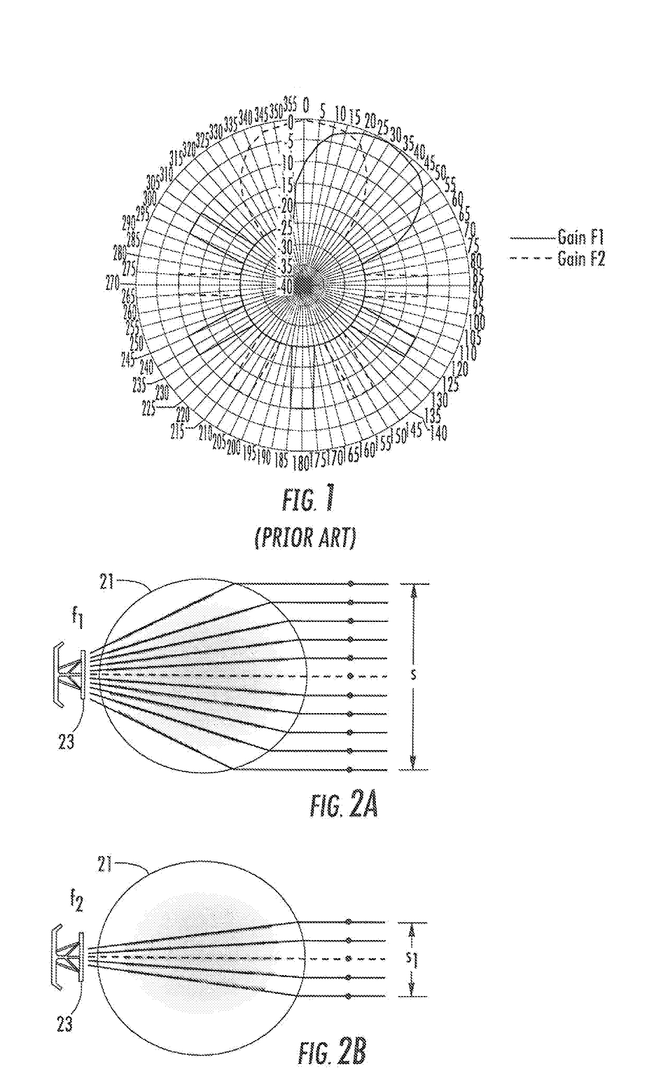

### DETAILED DESCRIPTION

Antennas have been developed that have multi-beam beam forming networks that drive a planar array of radiating elements, such as a Butler matrix. Multi-beam beam forming networks, however, have several potential disadvantages, including non-symmetrical beams and problems associated with port-to-port isolation, gain loss, and/or a narrow bandwidth. Multi-beam antennas have also been proposed that use Luneburg lenses, which are multi-layer lenses, typically spherical in shape, that have dielectric materials having different dielectric constants in each layer.

U.S. Patent Publication No. 2015/0091767 (“the '767 publication”), which is hereby incorporated by reference in its entirety, proposes a multi-beam antenna that has linear arrays of radiating elements and a cylindrical RF lens that is formed of a composite dielectric material.

Embodiments of the present invention will now be discussed in further detail with reference to the drawings, in which example embodiments are shown.

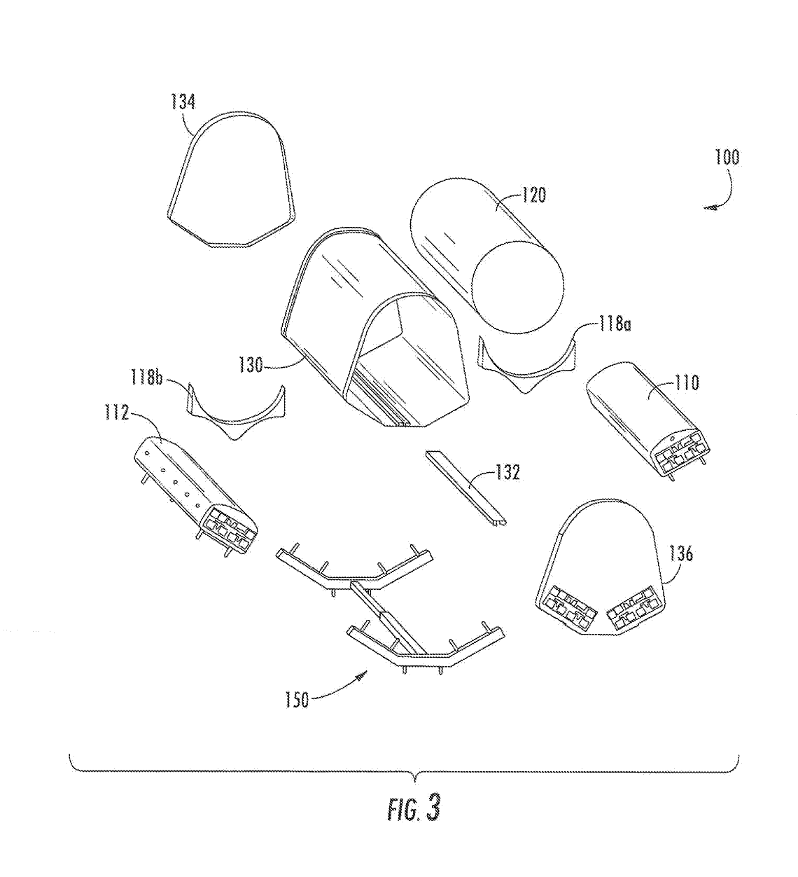

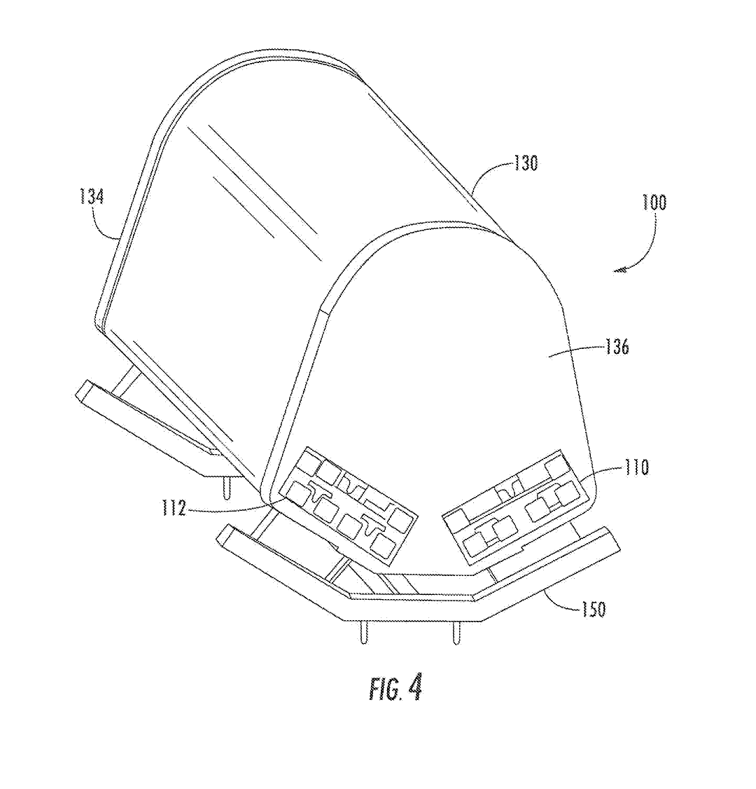

Reference is now made to FIGS. 2A and 2B, which are schematic side views illustrating azimuth beam width stability in a lens antenna according to some embodiments of the present invention. In the illustrated embodiments, the antenna includes a radiating element 23 that is operable to radiate an electromagnetic beam to a cylindrical lens 21. The cylindrical lens 21 may serve to focus the electromagnetic beam. The radiating element 23 may be a wideband or ultra wideband radiating element. The radiating element 23 may be designed to transmit and receive signals in the 1.7-2.7 GHz frequency range. In order to achieve azimuth beam stability when radiating element 23 is used with a lens, the ratio of the electric field aperture S1 to the electric field aperture S2 is about equal to the ratio of wavelength λ1 of the frequency f1 at the lower end of the frequency range (e.g., 1.7 GHz) to the wavelength λ2 of frequency f2 at the upper end of the frequency range (e.g., 2.7 GHz). For any given electromagnetic beam, the wavelength and frequency are inversely proportional to one another. Since wavelength and frequency are inversely proportional, it follows that when f1 is greater than f2 then S2 is greater than S1. As such, if the radiating element 23 is designed so that the ratio of the electric field aperture S1 to the electric field aperture S2 is equal to the ratio of the wavelength λ1 to the wavelength λ2, the azimuth beam width is substantially constant. As described herein, radiating units that each includes a pair of radiating elements that are proximate one another to provide different electric field apertures at different frequencies. For example, at one end of a frequency range the pair of radiating elements may be capacitively coupled and act as a single radiator having a −12 dB azimuth beam width that corresponds to the electric field aperture size corresponding to the pair of the radiating elements. At the other end of the frequency range, the pair of radiating elements may act as individual radiators having a −12 dB azimuth beam width that corresponds to the electric field aperture size corresponding to the individual radiators of the pair of radiating elements. This may provide azimuth beam width stability in a lensed antenna.

For optimal wideband/ultra-wideband performance, a full lens should be illuminated for the lowest frequency of bandwidth and the central area should be illuminated for the highest frequency.

The use of a cylindrical lens may reduce grating lobes (and other far sidelobes) in the elevation plane. This reduction is due to the lens focusing the main beam only and defocusing the far sidelobes. This allows increased spacing between the radiating elements. In non-lensed antennas, the spacing between radiating elements in the array may be selected to control grating lobes using the criterion that dₘₐₓ/λ<1/(sin θ₀+1), where dₘₐₓ is the maximum allowed spacing, λ is the wavelength and θ₀ is scan angle. In the lensed antenna, spacing dₘₐₓ can be increased: dₘₐₓ/λ=1.21^{˜}0.3[1/(sin θ₀+1)]. So, the lens allows the spacing between radiating elements to be increased for the base station antenna thus reducing the number of radiating elements by 20-30% or more.

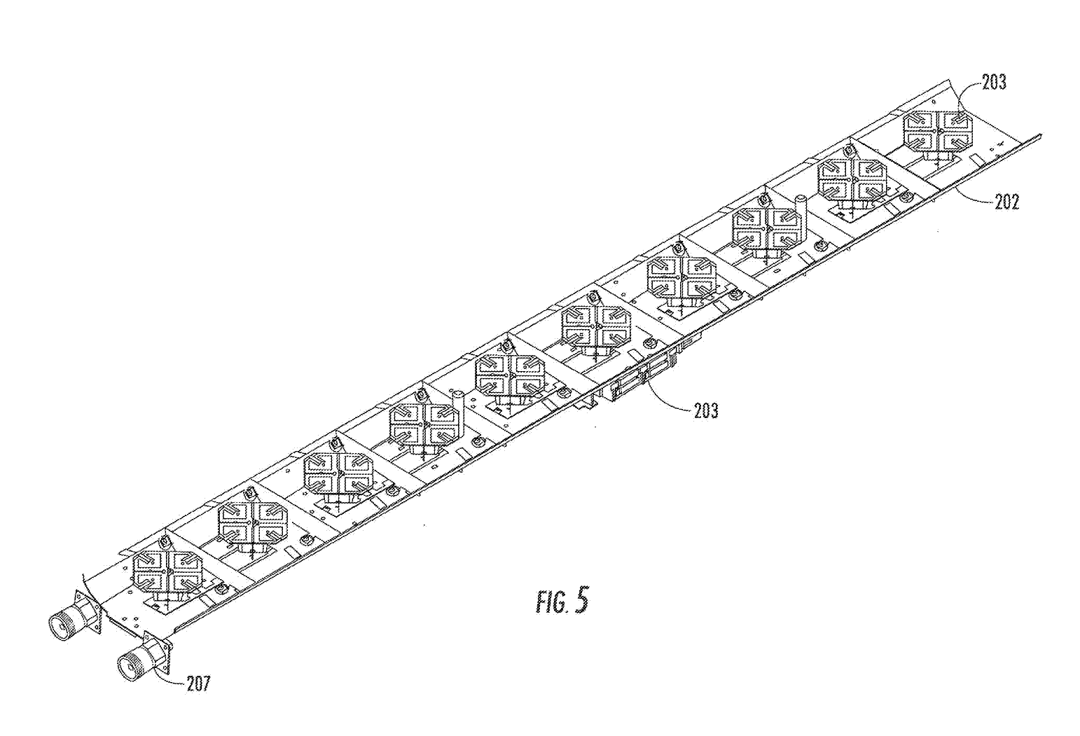

Reference is now made to FIG. 3, which illustrates a multi-beam base station antenna system 100 in an exploded perspective view according to some embodiments of the present invention. The multiple beam antenna system 100 includes a first antenna 110, a second antenna 112, a lens 120, top and bottom lens supports 118a and 118b, a shroud 130, a shroud locking device 132, a top end cap 134, a bottom end cap 136, and a telescopic mounting structure 150. An assembled view of the multiple beam antenna is illustrated in FIG. 4. It will be appreciated that while FIGS. 3-4 illustrate a multi-beam base station antenna system formed using two separate antennas 110, 112, in other embodiments the two antennas 110, 112 may be replaced with a single base station antenna that has multiple linear arrays of radiating elements.

In operation, the lens 120 narrows the half power beam width (HPBW) of the antennas 110 and 112 and increases the gain of the antennas 110 and 112. For example, the longitudinal axes of columns of radiating elements of the first and second antennas 110 and 112 can be aligned with the lens 120. Both antennas 110 and 112 may share the single lens 120, so both antennas 110 and 112 have their HPBW altered in the same manner. In one example, the HPBW of a 65° HPBW antenna is narrowed to about 33° by the lens 120.

The lens 120 may comprise a variation on a Luneberg lens. A conventional Luneberg lens is a spherically symmetric lens that has a varying index of refraction inside it. In some embodiments, the lens is shaped as a cylinder. The lens 120 may or may not include layers of dielectric material having different dielectric constants.

In some embodiments, the lens 120 is modular in the direction of the longitudinal axis of the cylinder. For example, a lens segment including a core and dielectric panels may be made in one-foot lengths, and an appropriate number of lens segments may be coupled in series to make lenses 120 of four to eight feet in length.

The top and bottom lens supports 118 and 118a space the lens 120 a desired distance from the first and second antennas 110 and 112. The lens 120 is spaced such that the apertures of the antennas 110, 112 point at a center axis of the lens 120. Instead of a cylindrical lens 120, some embodiments provide that a single-column phased array antenna includes a plurality of spherical and/or elliptical RF lenses. A telescopic mounting structure 150 includes a mounting structure that telescopes to adapt to antennas of different lengths.

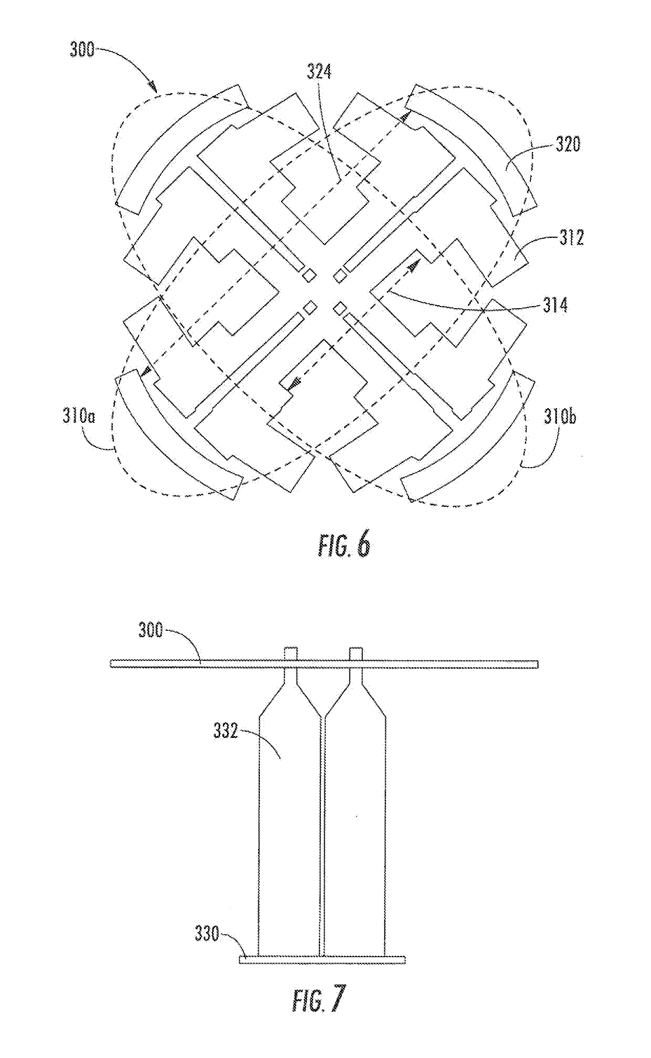

Some embodiments provide that the first and second antennas 110 and 112 include a linear antenna array 200 of radiating elements that may be arranged parallel to the length of the lens 120. For example, brief reference is now made to FIG. 5, which is a schematic of an example linear antenna array for use in a multi-beam base station antenna system according to some embodiments of the present invention. The linear antenna array 200 for use in a multi-beam base station antenna system includes a plurality of radiating elements 204, reflector 202, one or more phase shifters/dividers 203, and input connectors 207. The phase shifters/dividers 203 may be used for beam scanning (beam tilting) in the elevation plane. Different combinations and/types thereof of radiating elements 204 are provided herein.

Reference is now made to FIGS. 6 and 7, which are, respectively, a schematic plan view and side view of a radiating unit 300 for azimuth beam width stabilization, according to some embodiments of the present invention. The radiating unit 300 includes a box radiating element 310 that may be a dual polarized radiating element according to some embodiments. The box radiating element 310 includes four dipoles 312 that are arranged in a square or “box” arrangement. Each pair of dipoles 312 is mounted on a feedstalk 332. The feed stalk 332 and the two dipoles 312 electrically connected thereto comprise a radiating element. Thus, each box element 310 may comprise two radiating elements 310a, 310b that radiate at linear orthogonal polarizations (slant)+45°/−45°.

The radiating unit 300 may also include a parasitic radiating element 320 that may include radiators that may be positioned adjacent opposite ones of opposing dipoles 312. The parasitic radiating elements 320 may share a same plane with the dipoles 312 and may be arranged in a spaced apart manner relative to a perimeter of the box element 310. In some embodiments, the pairs of opposing ones of the dipoles 312 of the box element 310 may spaced apart from one another by a first distance 314 and opposing ones of the parasitic radiating elements 320 be spaced apart from one another by a second distance 324 that is greater than the first distance 314. As shown in FIG. 6, two of the parasitic radiating elements are part of radiating element 310a and the other two of the parasitic radiating elements are part of the radiating element 310b.

Some embodiments provide that the second distance 324 that is between the parasitic radiating elements 320 is greater that the first distance 314. Some embodiments provide that the parasitic radiating element 320 may be capacitively coupled with the box element 310 to resonate at higher frequencies than the box element 310 alone. At lower frequencies, the box element 310 may resonate without the capacitive coupling to the parasitic radiating elements 320. By providing resonance at the higher frequencies with the parasitic radiating elements 320 and resonance at the lower frequencies using the box element 310, the azimuth beam width stability may be improved.

For example, the box element 310 may resonate more effectively at about 1.7 GHz, which may be a low end of a broadband frequency range. In contrast, the parasitic radiating element 320 may resonate more effectively at about 2.7 GHz, which may be a high end of a broadband frequency range. As such, azimuth beam width stability in a lens antenna may be improved.

It will be appreciated that any appropriate radiating elements may be used. For example, in other embodiments, the linear arrays 200 may include radiating elements that are configured to radiate in different frequency bands. Each radiating element pair 300 may also include a ground plane 330 that is positioned behind the elements 310, 320 so that, for example, the dipoles 312 are adjacent one end of feed stalks 332 and the ground plane 330 is adjacent the other end of the feed stalks 332. As noted above, the ground plane 330 may comprise a mounting structure.

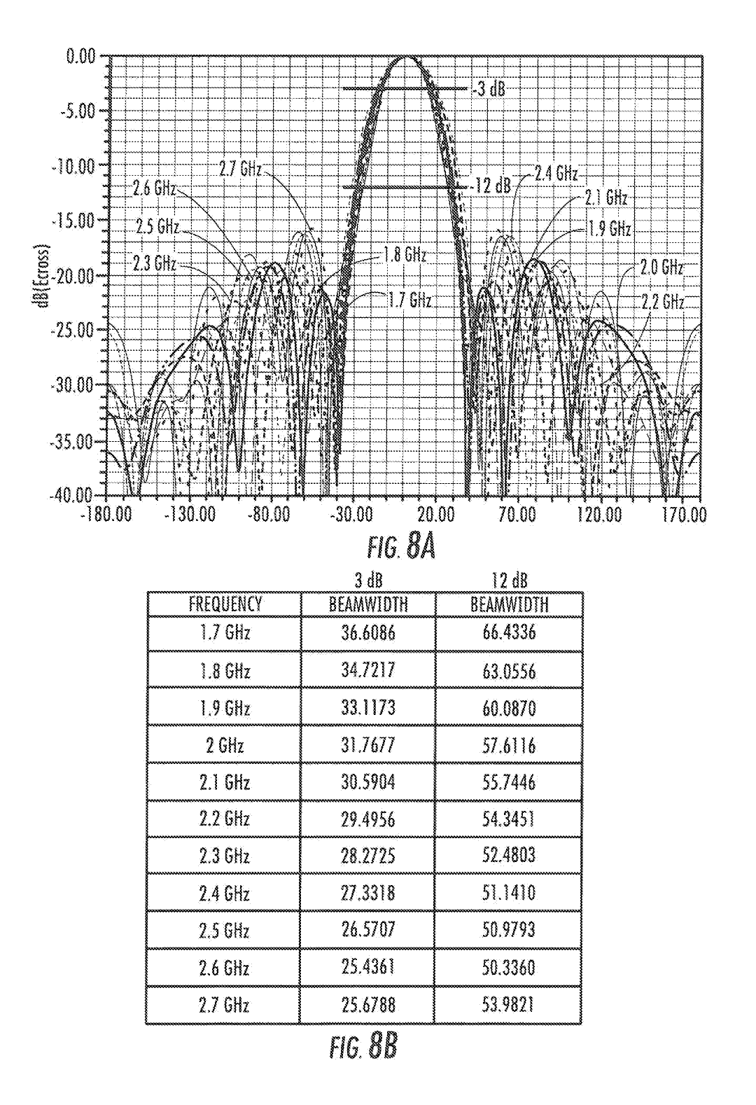

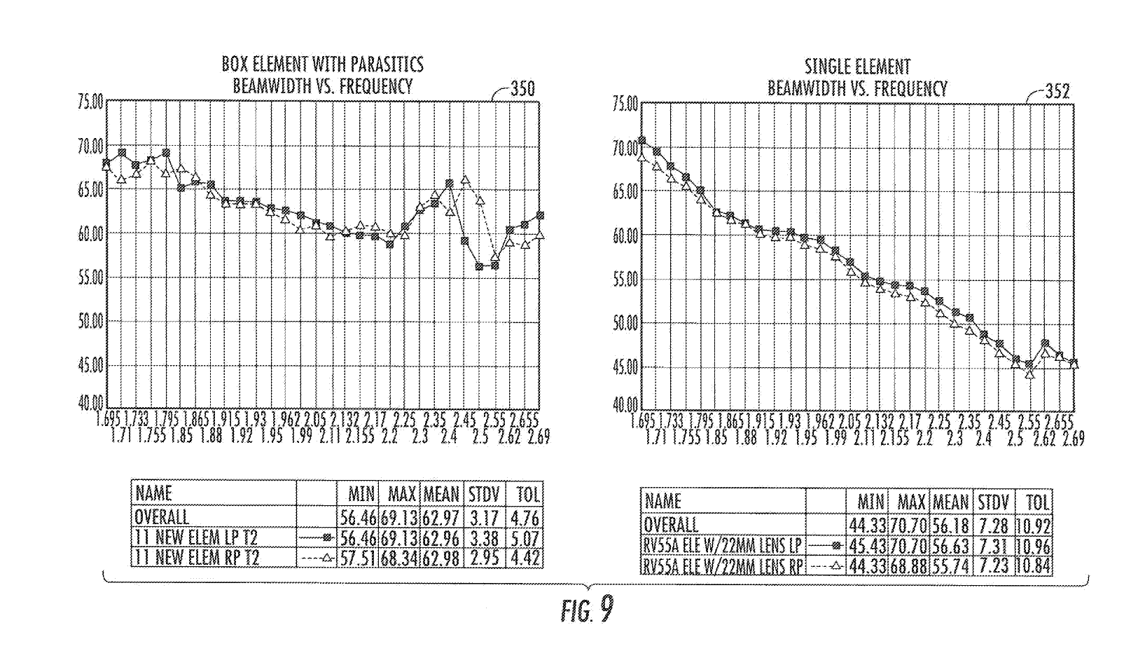

Reference is now made to FIGS. 8A and 8B, which are a graph illustrating plots of azimuth antenna patterns for 10 different transmission frequencies for one of the radiating elements 310a, 310b described with reference to FIG. 6 and a respective table including data corresponding to the graph. As illustrated in FIGS. 8A and 8B, the 3 dB azimuth beam width across frequencies from 1.7 GHz to 2.7 GHz ranges from about 25.4361 degrees to about 36.6086 degrees, which is a range of about 11.1725 degrees. Additionally, the 12 dB azimuth beam width across frequencies from 1.7 GHz to 2.7 GHz ranges from about 50.3360 degrees to about 66.4336 degrees, which is a range of about 16.0976 degrees.

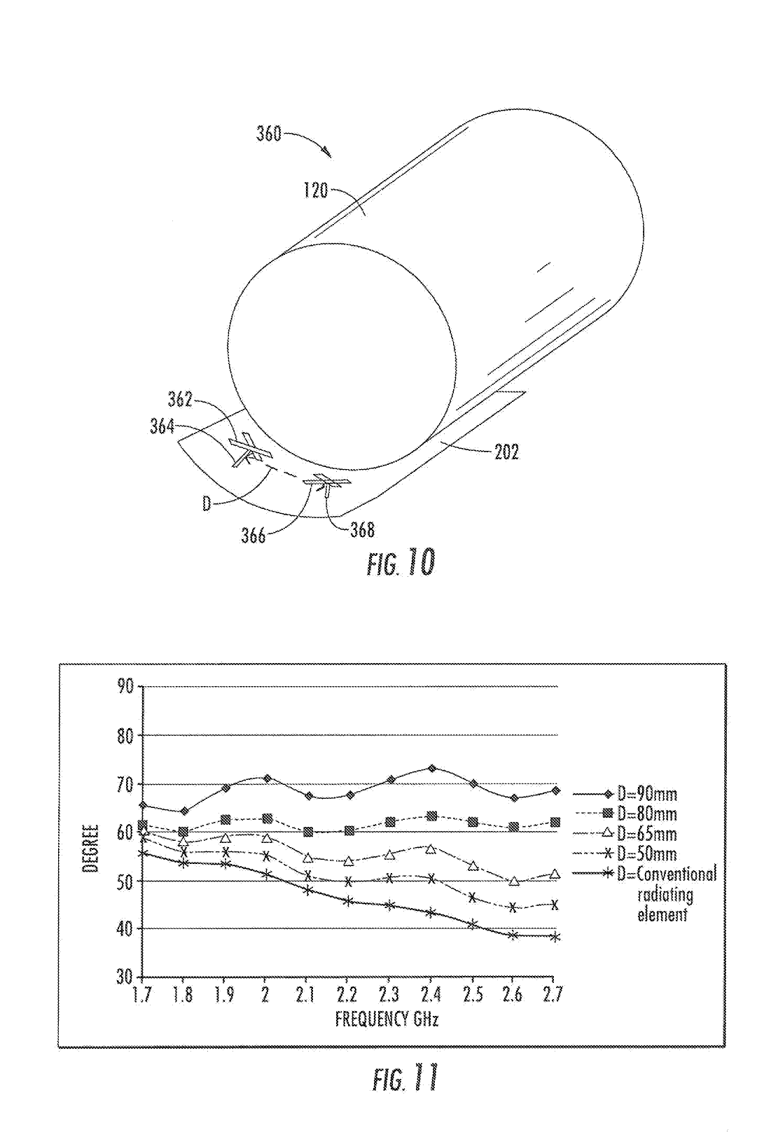

Brief reference is now made to FIG. 9, which illustrates plots of azimuth beam width versus frequency of one of the radiating elements 310a of the radiating unit 300 as described above regarding FIG. 6 (which includes the parasitic elements 320) and a conventional radiating element that does not include the parasitic elements 320. The first plot 350 illustrates the azimuth beam width versus frequency of the radiating element 310a that includes the parasitic elements 320. As provided in the table illustrated below the first plot 350, the overall standard deviation in azimuth beam width across the 1.0 GHz frequency range, which is inversely proportional to azimuth beam width stability, is about 3.17. The second plot 352 illustrates the azimuth beam width versus frequency of a conventional radiating element that does not include any parasitic element. As provided in the table illustrated below the second plot 352, the overall standard deviation in azimuth beam width across the 1.0 GHz frequency range, which is inversely proportional to azimuth beam width stability, is about 7.28. Accordingly, as evidenced by the significantly lower standard deviation value of the radiating element 310a, the azimuth beam width stability of the radiating element 310a is improved relative to that of the conventional radiating element.

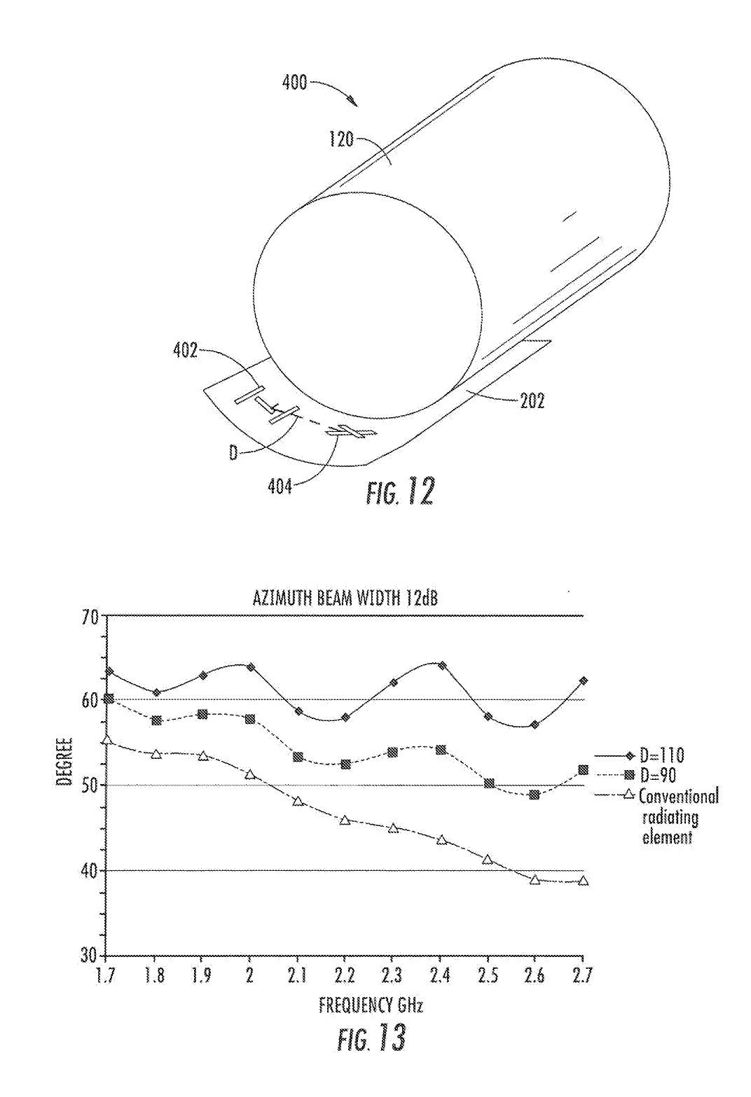

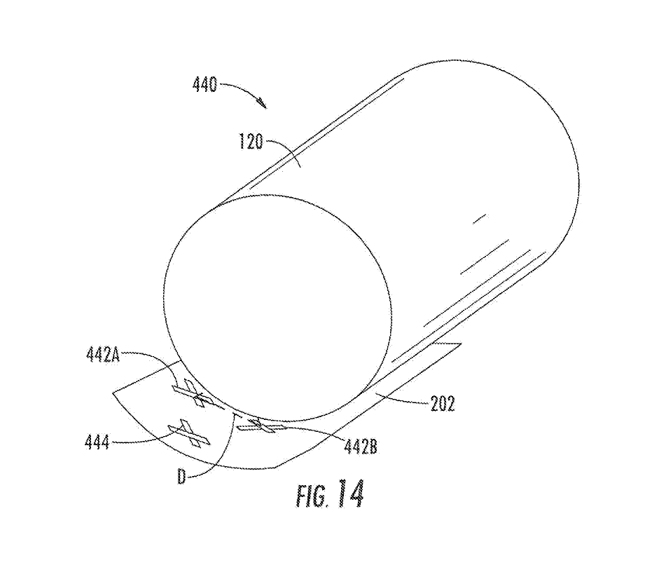

Reference is now made to FIGS. 10 and 11, which are a partial schematic perspective view of a lensed antenna 360 including pairs of radiating elements and a graph plotting azimuth beam width at a 12 dB reduction from peak emission (herein the −12 dB azimuth beam width) versus frequency according to some embodiments of the present invention. The lensed antenna 360 includes a cylindrical lens 120, a reflector 202 and pairs of radiating elements 362, 366 that are arranged between the reflector 202 and the lens 120. In some embodiments, the first radiating element 362 may be a cross dipole radiating element. Additionally, some embodiments provide that the second radiating element 366 is a cross-dipole radiating element that is radially spaced apart from the first radiating element 362 by a center-to-center distance “D” therebetween. Although only a single pair of radiating elements 362, 366 is illustrated, the lensed antenna 360 includes an array of the radiating elements 362, 366 that are spaced apart from one another in a direction that is parallel to a longitudinal axis of the cylindrical lens 120. Additionally, the lensed antenna 360 may include at least two such arrays to operate as a multi-beam antenna.

In some embodiments, the center-to-center distance D between the first and second radiating elements 362, 366 is in a range from about 50 mm to about 90 mm. Some embodiments provide that this range is from about 80 mm to about 90 mm. In some embodiments, the variation in the −12 dB azimuth beam width over a frequency range of 1.7 GHz to 2.7 GHz is less than about five degrees. In some embodiments, the center-to-center distance between radiating elements described herein may be defined in terms relative to either of the first or second frequencies. For example, some embodiments provide that the center-to-center distances and/or ranges thereof may be expressed in terms of the wavelength corresponding to one or more of the frequencies and/or ranges thereof.

The first and second radiating elements 362, 366 may be excited to transmit electromagnetic radiation in the same phase and having the same polarity.

Referring to FIG. 11, the multiple plots illustrate the −12 dB azimuth beam width across the frequency range of 1.7 GHz to 2.7 GHz for a conventional radiating element and for the first and second radiating elements 362, 366 according to some embodiments of the present invention arranged at the distances D of 50 mm, 65 mm, 80 mm and 90 mm. As illustrated, the conventional radiating element has a −12 dB azimuth beam width that ranges from about 56 degrees to about 39 degrees, which is a variation of about 17 degrees across the cited frequency range. The plot of the first and second radiating elements 362, 366 that are spaced 50 mm apart has a −12 dB beam width that ranges from about 58 degrees to about 46 degrees, which is a variation of about 12 degrees. The lower variation indicates an improvement in azimuth beam width stability.

The plot of the first and second radiating elements 362, 366 that are spaced 65 mm apart has a −12 dB beam width that ranges from about 60 degrees to about 50 degrees, which is a variation of about 10 degrees. The 10 degree variation indicates an improvement in azimuth beam width stability as compared to both the conventional radiating element and the first and second radiating elements 362, 366 that are spaced apart by 50 mm.

The plot of the first and second radiating elements 362, 366 that are spaced 90 mm apart has a −12 dB beam width that ranges from about 65 degrees to about 74 degrees, which is a variation of about 9 degrees. The 9 degree variation indicates an improvement in azimuth beam width stability as compared to the conventional radiating element and the first and second radiating elements 362, 366 spaced apart by 50 mm and 65 mm.

The plot of the first and second radiating elements 362, 366 that are spaced 80 mm apart has a −12 dB beam width that ranges from about 60 degrees to about 63 degrees, which is a variation of about 3 degrees. The 3 degree variation is the lowest variation of those tested and thus provides the best azimuth beam width stability relative to the conventional radiating element and the other examples.

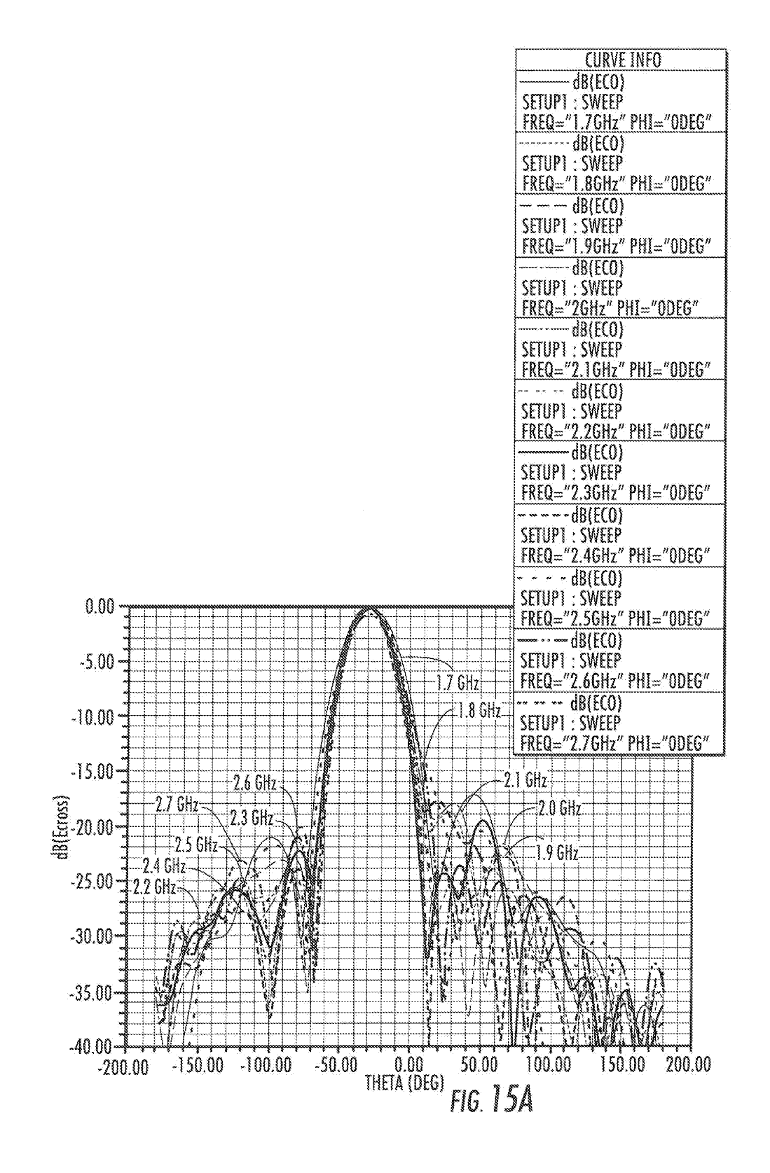

Reference is now made to FIGS. 12 and 13, which are a partial schematic perspective view of a lensed antenna 400 including pairs of radiating elements and a graph plotting the −12 dB azimuth beam width versus frequency according to some other embodiments of the present invention. The lensed antenna 400 includes a cylindrical lens 120, a reflector 202 and one of more pairs of radiating elements 402, 404 that are arranged between the reflector 202 and the lens 120. In some embodiments, the first radiating element 402 may horizontal-vertical dipole structure that may be referred to as a “tree element”. The tree element 402 may include a pair of spaced apart vertical radiating elements and a horizontal radiating element spaced between the two vertical radiating elements. The second radiating element 404 may include a cross-dipole radiating element that is radially spaced apart from the first radiating element 402 by a center-to-center distance “D” therebetween. The second radiating element 404 may be similar to the second radiating element 366 as discussed above regarding FIG. 10.

Although only a single pair of radiating elements 402, 404 is illustrated, the lensed antenna 400 includes an array of the radiating elements 402, 404 that are spaced apart from one another in a direction that is parallel to a longitudinal axis of the cylindrical lens 120. Additionally, the lensed antenna 400 may include at least two such arrays to operate as a multi-beam antenna.

In some embodiments, the center-to-center distance D between the first and second radiating elements 402, 404 is in a range from about 90 mm to about 110 mm. In some embodiments, the variation in the −12 dB azimuth beam width over the frequency range from 1.7 GHz to 2.7 GHz is less than about seven degrees.

The vertical and horizontal elements of the first radiating element 402 may be excited by plus and minus 45 degree polarization, respectively.

Referring to FIG. 13, the multiple plots illustrate the −12 dB azimuth beam width across the frequency range of 1.7 GHz to 2.7 GHz for a conventional radiating element and for the first and second radiating elements 402, 404 arranged at the distances D of 90 mm and 110 mm. As illustrated, the conventional radiating element plot shows a variation in azimuth beam width from about 55 degrees to about 39 degrees, which is a variation of about 16 degrees across the cited frequency range. The plot for the first radiating element 402 being a tree element and the second radiating element 404 being a cross dipole radiating element spaced 90 mm apart shows a variation in azimuth beam width from about 60 degrees to about 48 degrees, which is a variation of about 12 degrees. The lower variation indicates an improvement in azimuth beam width stability by the first and second radiating elements 402, 404 as compared to the conventional radiating element.

The plot for the first and second radiating element 402 being a tree element and the second radiating element 404 being a cross dipole radiating element that are spaced 110 mm apart shows a variation in the azimuth beam width from about 65 degrees to about 58 degrees, which is a variation of about 7 degrees. The 7 degree variation indicates an improvement in azimuth beam width stability as compared to both the first and second radiating elements 402, 404 that are spaced apart by 90 mm and the conventional radiating element. The 7 degree variation is the lowest variation for this tree element/cross dipole and thus provides the best azimuth beam width stability relative to the other examples.

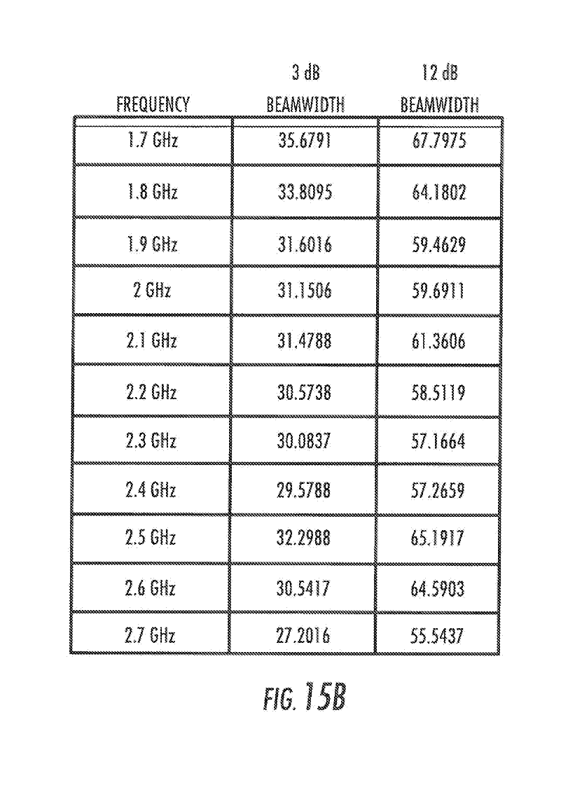

Reference is now made to FIG. 14, which is a partial schematic perspective view of a lensed antenna 440 including pairs of radiating elements according to some embodiments of the present invention. The lensed antenna 440 includes a cylindrical lens 120, a reflector 202 and first and second radiating elements 442, 444 that are arranged between the reflector 202 and the lens 120. In some embodiments, the first radiating element 442 may include a pair of cross dipole radiating elements 442A, 442B that are radially spaced apart from one another by a center-to-center distance “D”.

Additionally, some embodiments provide that the second radiating element 444 is a single cross-dipole radiating element that is longitudinally spaced apart from the first radiating element 442. Although only radiating elements 442, 444 are illustrated, the lensed antenna 400 includes an array of the radiating elements 442, 444 that are spaced apart from one another in a direction that is parallel to a longitudinal axis of the cylindrical lens 120. Some embodiments provide that the first and second radiating elements 442, 444 alternate along the length of the array.

In some embodiments, the center-to-center distance D between the pair of cross dipole radiating elements 442A, 442B is in a range from about 80 mm to about 100 mm. Some embodiments provide that the variation in −12 dB azimuth beam width over the frequency range from 1.7 GHz to 2.7 GHz is less than about five degrees.

In some embodiments, the lens antenna 440 comprises a dual beam wideband antenna. For example, the lens antenna 440 may include more than one arrays of radiating elements that are configured to radiate through the lens at different angles.

Reference is now made to FIGS. 15A and 15B, which are a graph illustrating plots of the azimuth radiation pattern for pairs of radiating elements described with reference to FIG. 14 at different respective frequencies in a broadband frequency spectrum and a respective table including data corresponding to the graph. As illustrated in FIGS. 15A and 15B, the −3 dB azimuth beam width across frequencies from 1.7 GHz to 2.7 GHz ranges from 27.2016 degrees to 35.6791 degrees, which is a range of 8.4775 degrees. Additionally, the −12 dB azimuth beam width across frequencies from 1.7 GHz to 2.7 GHz ranges from 55.5437 degrees to 67.7975 degrees, which is a range of 12.2538 degrees.

The data corresponding to FIGS. 15A and 15B are for a lensed antenna 440 in which the distance between the pair of cross dipole radiating elements 442A, 442B is about 90 mm, the radius of the cylindrical lens 120 is about 110 mm, and the distance from the center of the lens 120 to the reflector 202 is about 175 mm.

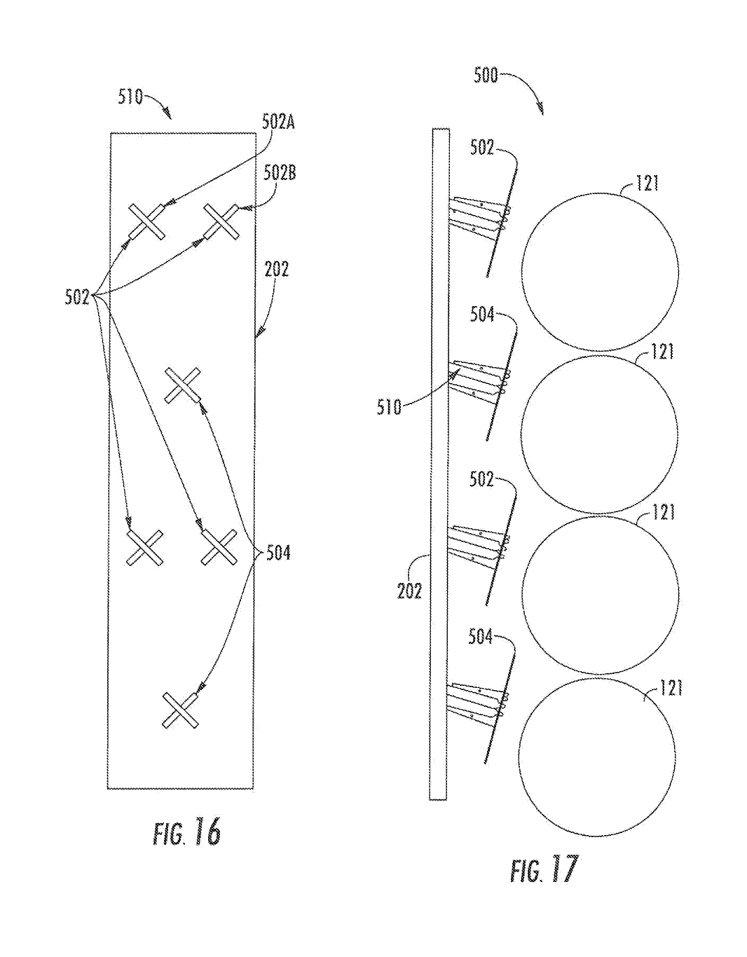

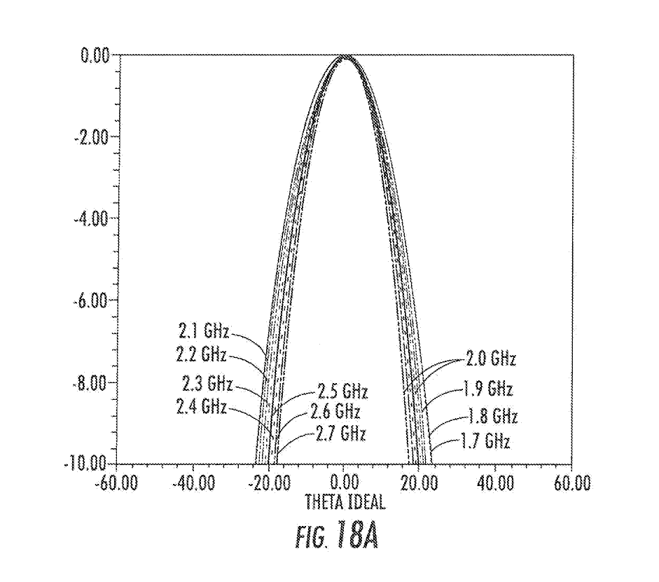

Reference is now made to FIGS. 16 and 17, which are a partial schematic diagram of a linear array of radiating elements and a schematic side view of a lensed base station antenna 500, respectively, according to some embodiments of the present invention.

As shown in FIG. 16, in one configuration, first radiating elements 502 that form a first linear array and second radiating elements 504 that form a second linear array may be mounted on a reflector 202. The radiating elements 502, 504 may be arranged together in a single column so that the linear arrays 502, 504 are colinear and interspersed. In the depicted embodiments, the first radiating elements 502 are implemented as a pair of adjacent cross dipole elements 502A, 502B. The second radiating elements may be implemented as single cross dipole elements 504.

Referring to FIG. 17, the base station antenna 500 comprises a single-column phased array antenna 500 that includes a spherical RF lens 121 for each radiating element 502, 504. The antenna 500 includes a multiple radiating elements 502, 504 that are mounted on a mounting structure 510. The RF lenses 121 may be mounted in a first column. The radiating elements 502, 504 may be mounted in a second column. When the antenna 500 is mounted for use, the azimuth plane is perpendicular to the longitudinal axis of the antenna 500, and the elevation plane is parallel to the longitudinal axis of the antenna 500. The radiating elements 502, 504 may or may not be tilted in the elevation plane (they are shown tilted in FIG. 17).

As shown in FIG. 17, each radiating element 502, 504 may be associated with a respective one of the spherical RF lens 121 in that each radiating element 502, 504 is configured to emit a radiation beam through its associated RF lens 121. The combination of a radiating element 502, 504 and its associated spherical RF lens 121 may provide a radiation pattern that is narrowed in both the azimuth and elevation directions.

It will also be appreciated that the amount that an RF lens shrinks the beam width of an antenna beam that passes therethrough varies with the frequency of the signals being transmitted and received by the antenna. In particular, the larger the number of wavelengths that an RF signal cycles through in passing through the lens, the more focusing that will occur with respect to the antenna beam. For example, as discussed above, a particular RF lens will shrink a 2.7 GHz beam more than a 1.7 GHz beam.

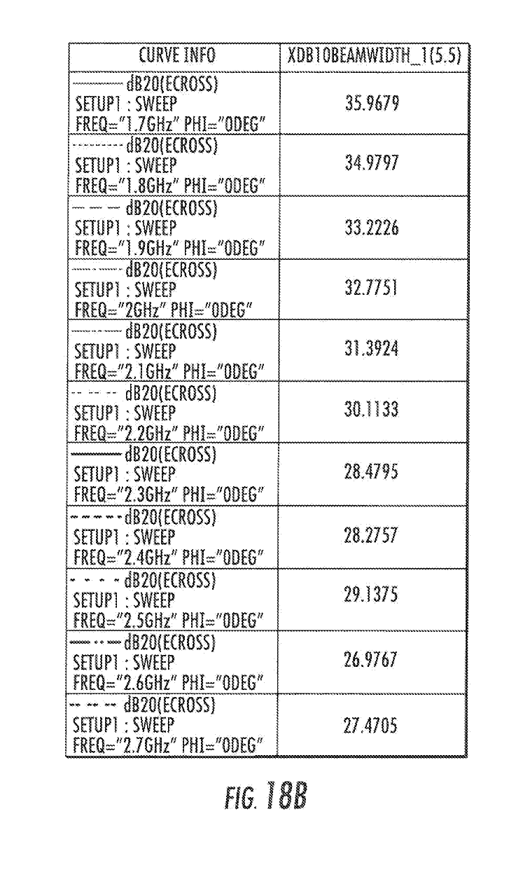

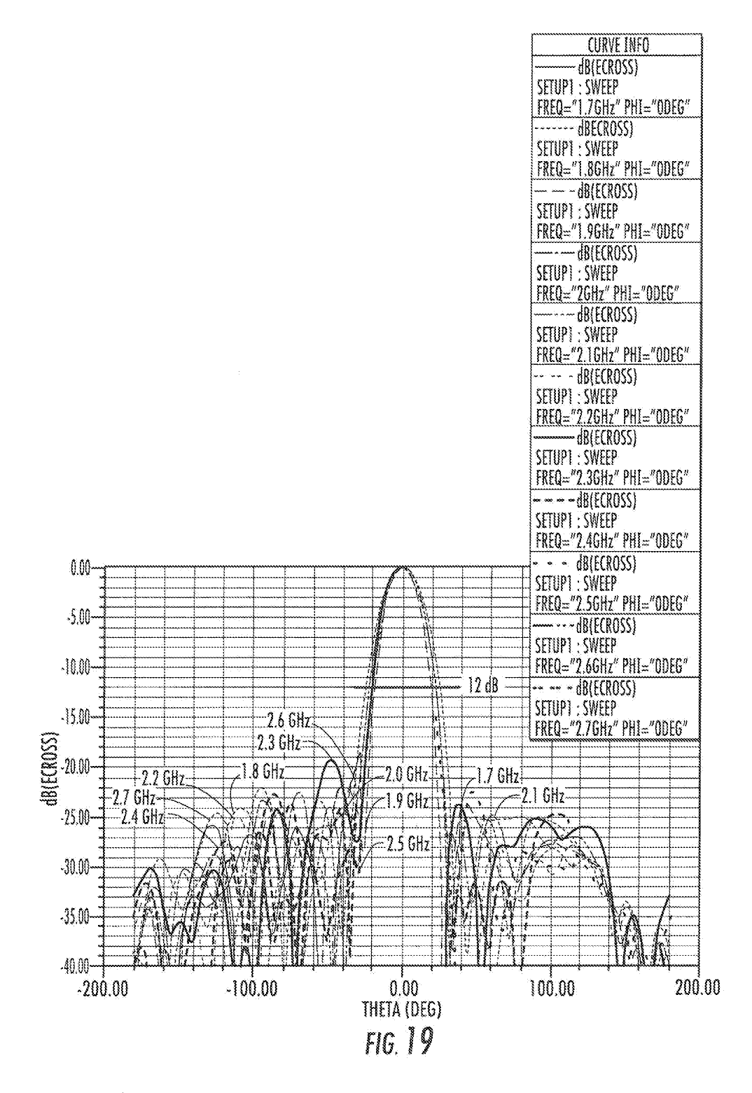

Reference is now made to FIGS. 18A and 18B, which are a graph illustrating plots of azimuth radiation patterns for pairs of radiating elements described with reference to FIGS. 16 and 17 at different respective frequencies in a broadband frequency spectrum and a respective table including data corresponding to the graph. As illustrated in FIGS. 18A and 18B, the 5.5 dB crossover beam width across frequencies from 1.7 GHz to 2.7 GHz ranges from 26.9767 degrees to 35.9679 degrees, which is a range of 8.9912 degrees.

The data corresponding to FIGS. 18A and 18B are for a lensed antenna 500 in which the distance between the first and second radiating elements 502, 504 is about 330 mm, the radius of the spherical lens 121 is about 165 mm, and the distance from the center of the lens 121 to the reflector 202 is about 245 mm.

Brief reference is now made to FIG. 19, which is a graph illustrating plots of azimuth radiation patterns for pairs of radiating elements described with reference to FIGS. 16 and 17 at different respective frequencies in a broadband frequency spectrum. In addition to the stabilized azimuth beam width performance to about 20 dB, FIG. 19 illustrates beneficial sidelobe performance of approximately 25 dB.

There are a number of antenna applications in which signals in multiple different frequency ranges are transmitted through the same antenna. One common example is multi-band base station antennas for cellular communications systems. Different types of cellular service are supported in different frequency bands, such as, for example, GSM service which uses the 900 MHz (namely 880-960 MHz) and 1800 MHz (namely 1710-1880 MHz) frequency bands, UTMS service which uses the 1920-2170 MHz frequency band, and LTE service which uses the 2.5-2.7 GHz frequency band. A single base station antenna may have multiple arrays of different types of radiating elements that support two or more different types of cellular service and/or may have wideband radiating elements that transmit and receive signals for multiple different types of service.

When an RF lens is used with such antennas (and where it is not possible or practical to use different RF lenses for different types of radiating elements), a Luneburg lens may be used to partially offset the effect that the difference in frequency has on the beam width of the antenna beams for the different frequency bands. However, in some cases, even when a Luneburg lens is used, the beam for the high frequency band may be more tightly focused than the beam for the lower frequency band. This may cause difficulties, since RF planners often want the coverage areas to be the same for each frequency band, or at least for all frequencies that are serviced by a particular column of radiating elements.

While not shown herein to simplify the drawing, it will be appreciated that the antennas disclosed herein may include a variety of other conventional elements (not shown) such as a radome, end caps, phase shifters, a tray, input/output ports and the like.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof. As used herein, the term “proportionally related” may describe proportional relationships including a positive constant of proportionality and inversely proportional relationships including a negative constant of proportionality.

Aspects and elements of all of the embodiments disclosed above can be combined in any way and/or combination with aspects or elements of other embodiments to provide a plurality of additional embodiments.

1. A lensed antenna, comprising:
a linear array of a plurality of radiating units that are spaced apart from one another in a longitudinal direction and that each include a first radiating element and a second radiating element that is arranged proximate to the first radiating element, wherein either of the first radiating element or the second radiating element is operable to resonate at a first frequency and a combination of the first radiating element and the second radiating element is operable to resonate at a second frequency that is different from the first frequency; and
a lens positioned to receive electromagnetic radiation from at least one of the plurality of radiating units,
wherein first electromagnetic radiation that exits the lens that corresponds to the first frequency comprises a first electric field aperture and second electromagnetic radiation that exits the lens that corresponds to the second frequency comprises a second electric field aperture that is different from the first electric field aperture.

2. The antenna according to claim 1, wherein an aperture ratio of the first electric field aperture to the second electric field aperture is proportionally related to a frequency ratio of the second frequency to the first frequency.

3. The antenna according to claim 2, wherein the aperture ratio is related to the frequency ratio by a constant of proportionality that is between 0.9 and 1.1.

4. The antenna according to claim 1,
wherein the lens comprises a cylindrical lens having a lens longitudinal axis, and
wherein the first radiating element comprises crossed dipoles and the second radiating element comprises crossed dipoles that are radially spaced apart from the first radiating element.

5. (canceled)

6. The antenna according to claim 4, wherein a center-to-center distance between the first radiating element and the second radiating element is in a range from about 0.3 times a wavelength corresponding to the second frequency to about 0.7 times the wavelength corresponding to the second frequency.

7. The antenna according to claim 4, wherein a center-to-center distance between the first radiating element and the second radiating element is in a range from about 0.5 times a wavelength corresponding to the second frequency to about 0.6 times the wavelength corresponding to the second frequency.

8. (canceled)

9. The antenna according to claim 4, wherein a −12 dB azimuth beam width variation of the antenna at a frequency range from 1.7 GHz to 2.7 GHz is greater than about two degrees and less than about five degrees.

10. The antenna according to claim 4, wherein a −12 dB azimuth beam width variation of the antenna at a frequency range from 1.7 GHz to 2.7 GHz is less than about eight percent of the 12 db azimuth beamwidth.

11. (canceled)

12. The antenna according to claim 1, wherein the first radiating element comprises a crossed dipole and the second radiating element comprises a horizontal-vertical hybrid dipole that is radially spaced apart from the first radiating element.

13. The antenna according to claim 12, wherein the horizontal-vertical hybrid dipole comprises:
two vertical radiating elements that are radially spaced apart from one another and that are spaced apart from one another in a direction that is parallel to the lens longitudinal axis; and
a horizontal radiating element that is between the two vertical radiating elements.

14. (canceled)

15. The antenna according to claim 12, wherein a center-to-center distance between the first radiating element and the second radiating element is in a range from about 0.6 times a wavelength corresponding to the second frequency to about 0.8 times the wavelength corresponding to the second frequency.

16. The antenna according to claim 1,
wherein the lens comprises a spherical lens array that includes a plurality of spherical lenses that are arranged adjacent one another in a first direction,
wherein the first radiating element comprises a first crossed dipole and the second radiating element comprises a second crossed dipole that is radially spaced apart from the first crossed dipole in a direction that is orthogonal to the first direction, and
wherein the first crossed dipole and the second crossed dipole are adjacent a corresponding one of the plurality of spherical lenses.

17. The antenna according to claim 16, further comprising a plurality of single crossed dipoles, wherein one of the plurality of single crossed dipoles is adjacent a second one of the plurality of spherical lenses.

18. The antenna according to claim 16,
wherein ones of the plurality of radiating units are arranged alternatively with ones of the single crossed dipoles in the first direction, and
wherein the plurality of spherical lenses comprise a spherical lens corresponding to each of the plurality of radiating units and the plurality of single dipoles.

19. (canceled)

20. The antenna according to claim 1,
wherein the lens comprises a cylindrical lens having a lens longitudinal axis that extends in a first direction, and
wherein the first radiating element comprises a first crossed dipole and the second radiating element comprises a second crossed dipole that is radially spaced apart from the first crossed dipole in a direction that is orthogonal to the first direction.

21. The antenna according to claim 1,
wherein the first radiating element comprises a box-style radiator that includes four dipoles arranged in a square, and
wherein the second radiating element comprises a parasitic radiator that includes parasitic elements that are adjacent a perimeter of the box-style radiator.

22. The antenna according to claim 21, wherein the box-style radiator is configured to resonate at a low end of a broadband frequency range, and
wherein a combination of the parasitic radiator and the box-style radiator is configured to resonate at a high end of the broadband frequency range.

23. (canceled)

24. A lensed antenna, comprising:
a plurality of radiating units that are arranged in a linear array, each of the plurality of radiating units comprising a first radiating element and a second radiating element that is arranged proximate to the second radiating element, wherein the first radiating element comprises a dipole and the second radiating element comprises a parasitic radiating element, wherein the first radiating element is operable to resonate at a first frequency and a combination of the first radiating element and the second radiating element is operable to resonate at a second frequency that is different from the first frequency; and
a lens positioned to receive electromagnetic radiation from the plurality of radiating units.

25. The antenna of claim 24, wherein first electromagnetic radiation that exits the lens that corresponds to the first frequency comprises a first electric field aperture and second electromagnetic radiation that exits the lens that corresponds to the second frequency comprises a second electric field aperture that is different from the first electric field aperture.

26. The antenna of claim 25, wherein an aperture ratio of the first electric field aperture to the second electric field aperture is related to a frequency ratio of the second frequency to the first frequency by a constant of proportionality that is between 0.8 and 1.2.
